(19) United States
(12) Patent Application Publication
(10) Pub. No.: US 2007/0077493 A1
(43) Pub. Date: Apr. 5, 2007

(54) Subfluorinated graphite fluorides as electrode materials

(75) Inventors: Rachid Yazami, Los Angeles, CA (US); Andre Hamwi, Clermont-Ferrand (FR)

Correspondence Address: GREENLEE WINNER AND SULLIVAN P C, 4875 PEARL EAST CIRCLE, SUITE 200, BOULDER, CO, 80301, US

(73) Assignee: California Institute of Technology, Pasadena, CA (US)

(21) Appl. No.: 11/253,360

(22) Filed: Oct. 18, 2005

Related U.S. Application Data
(60) Provisional application No. 60/724,084, filed on Oct. 5, 2005.

(51) Int. Cl. H01M 4/58; H01M 4/62; H01M 4/40

(52) U.S. Cl. 429/231.7; 429/232; 429/217; 429/231.4; 429/231.95

(57) ABSTRACT

Subfluorinated graphite fluorides of formula CFₓ, wherein x is in the range of 0.06 to 0.63, e.g., 0.10 to 0.46, are used as electrode materials in electrochemical devices that convert chemical energy to electrical current, e.g., batteries. The invention additionally provides methods of manufacturing electrodes with the subfluorinated graphite fluorides, as well as primary and secondary batteries containing such electrodes.

### CROSS REFERENCE TO RELATED APPLICATION

This application claims priority under 35 U.S.C. § 119(e)(1) to Provisional U.S. patent application Ser. No. ______ for “Physical Characteristics and Rate Performance of (CFₓ)ₙ(0.33<x<0.66) in Lithium Batteries,” filed Oct. 5, 2005, which is incorporated herein by reference in its entirety.

### FIELD OF THE INVENTION

This invention relates generally to electrode materials, and more particularly relates to the use of fluorinated carbon, particularly subfluorinated graphite fluorides, as electrode materials in electrochemical devices for generating electrical current, e.g., lithium batteries.

### BACKGROUND OF THE INVENTION

Since the pioneering work of Ruff et al. (1934) Z. Anorg. Allg. Chem. 217: 1, and of Rudorff et al. (1947) Z. Anorg. Allg. Chem. 253:281, graphite has been known to react with elemental fluorine at high temperatures to yield graphite fluoride compounds of general formula (CFₓ)ₙ. Systematic studies on the fluorination reaction later showed that the resulting F/C ratio is largely dependent on the fluorination temperature, the partial pressure of the fluorine in the fluorinating gas, and physical characteristics of the graphite precursor, including the degree of graphitization, particle size, and specific surface area. See Kuriakos et al. (1965) J. Phys. Chem. 69:2272; Nanse et al. (1997) Carbon 35:175; Morita et al. (1980) J. Power Sources 5:111; Fujimoto (1997) Carbon 35:1061; Touhara et al. (1987) 2. Anorg. All. Chem. 544:7; Watanabe et al. (1974) Nippon Kagaku Kaishi 1033; and Kita et al. (1979) J. Am. Chem. Soc. 101:3832.

The crystal structure of highly fluorinated graphite fluorides, i.e., (CFₓ)ₙ compounds with x>>0.5, has been investigated by several groups (Nakajima et al., Graphites, Fluorides and Carbon-Fluorine Compounds, CRC Press, Boca Raton, Fla., p. 84; Charlier et al. (1994) Mol. Cryst. Liq. Cryst. 244:135; Charlier et al. (1993), Phys. Rev. B 47:162; Mitkin et al. (2002) J. Struct. Chem. 43: 843; Zajac et al. (2000) J. Sol. State Chem. 150:286; Gupta et al. (2001) J. Fluorine Chem., 1 10-245; Ebert et al. (1 974) J. Am. Chem. Soc. 96:7841; Pelikan et al. (2003) J. Solid State Chem. 174:233; and Bulusheva et al. (2002) Phys. Low-Dim. Struct. 718:1). The Watanabe group first proposed two phases: a first stage, (CF₁)ₙ, and a second stage, (CF_{0.5})ₙ, the latter also commonly referred to as (C₂F)ₙ, (Touhara et al., supra). In first stage materials, the fluorine is intercalated between each carbon layer to yield stacked CFCF layers, whereas in second stage materials, fluorine occupies every other layer with a stacking sequence of CCFCCF. Hexagonal symmetry was found to be preserved in both (CF₁)ₙ, and (CF_{0.5})ₙ, phases. Theoretical crystal structure calculations were also carried out and different layer stacking sequences were compared using their total energy (Charlier et al. (1994), supra; Charlier et al. (1993) Phys. Rev. B 47:162; and Zajac et al., Pelikan et al., and Bulusheva et al., all supra).

(CFₓ)ₙ, compounds are generally non-stoichiometric with x varying between ˜0 and ˜1.3. For x<0.04, fluorine is mainly present on the surface of the carbon particles (Nakajima et al. (1999) ElectrochemicaActa 44:2879). For 0.5<x<51, it has been suggested that the material consists of a mixture of two phases, (CF_{0.5})ₙ, and (CF₁)ₙ. “Overstoichiometric compounds,” wherein 1<x<˜1.3, consist of (CF₁)_{N} with additional perfluorinated —CF₂ surface groups (Mitkin et al., supra). Surprisingly, although they have been reported in the literature (Kuriakos et al., supra; Nakajima et al. (1999) Electrochemica Acta 44:2879; and Wood et al. (1973) Abs. Am. Chem. Soc. 121), covalent type (CFₓ)ₙ materials with x<0.5 have not been investigated in view of their crystal structure characterization. One possible reason of the focus on the fluorine-rich materials comes from their potential application as lubricants and as cathode materials for primary lithium batteries. In fact, for the latter application, the energy density of the battery, which is determined by its discharge time at a specific rate and voltage, has been found to be an increasing function of x.

The cell overall discharge reaction, first postulated by Wittingham (1975) Electrochem. Soc. 122:526, can be schematized by equation (1):
(CFₓ)ₙ+xnLi [symbol] nC+nx LiF (1)

Thus, the theoretical specific discharge capacity Qₜₕ, expressed in mAh·g-¹, is given by equation (2):

$${Q}_{th} ( x ) = \frac{x F}{3.6 ( 12 + 19 x )} \qquad ( 2 )$$

where F is the Faraday constant and 3.6 is a unit conversion constant.

The theoretical capacity of (CFₓ)ₙ materials with different stoichiometry is therefore as follows: x=0.25, Qₜₕ=400 mAh·g-¹; x=0.33, Qₜₕ=484 mAh ·g-¹; x=0.50, Qₜₕ=623 mAh·g-¹; x=0.66, Qₜₕ=721 mAh·g-¹; and x=1.00, Qₜₕ=865 mAh·g-¹. It is interesting to note that even a low fluorine-containing (CF_{0.25})ₙ material yields a higher theoretical specific capacity than MnO₂, i.e., 400 mAh·g-¹ versus 308 mAh·g-¹, respectively. Despite the higher capacity, longer shelf life (on the order of 15 years), and substantial thermal stability of (CF_{0.25})ₙ, MnO₂ is the most widely used solid state cathode in primary lithium batteries, in part because of lower cost, and in part because of a higher rate capability.

The lower rate performance of Li/(CF) batteries is presumably due to the poor electrical conductivity of the (CF)ₙ, material. In fact, the fluorination of graphite at high temperature (typically 350° C.≦T≦650° C.) induces a dramatic change in the stereochemical arrangement of carbon atoms. The planar sp² hybridization in the parent graphite transforms into a three-dimensional Sp³ hybridization in (CFₓ)ₙ. In the latter, the carbon hexagons are “puckered,” mostly in the chair conformation (Rudorff et al., Touhara et al., Watanabe et al., Kita et al., Charlier et al., Charlier et al., Zajac et al., Ebert et al., Bulusheva et al., and Lagow et al., all cited supra). Electron localization in the C—F bond leads to a huge drop of the electrical conductivity from ˜1.7 10⁴ S·cm⁻¹ in graphite to ˜10⁻¹⁴ S·cm⁻¹ in (CF)ₙ (Touhara et al., supra).

Accordingly, there is a need in the art for electrode materials that would compensate for the low conductivity of fluorinated carbon materials while preserving their high thermal stability and high discharge capacity. Ideally, such electrodes would enable, for example, the manufacture of lithium batteries having increased battery performance when discharged, particularly at high rates.

### SUMMARY OF THE INVENTION

The invention is directed to the aforementioned need in the art, and is premised on the discovery that electrodes fabricated with “subfluorinated” carbon materials, e.g., graphite fluorides CFₓ where x is in the range of 0.06 to 0.63, provide increased battery performance upon discharge at a high rate.

In one aspect of the invention, then, an electrochemical device is provided that comprises an anode, a cathode, and an ion-transporting material therebetween, wherein the cathode comprises a subfluorinated graphite fluoride of formula CFₓ in which x is in the range of 0.06 to 0.63. The anode includes a source of ions corresponding to a metal element of Groups 1, 2, or 3 of the Periodic Table of the Elements, e.g., lithium.

In another aspect of the invention, the aforementioned electrochemical device is a primary lithium battery in which the anode comprises a source of lithium ions, the cathode comprises a subfluorinated graphite fluoride having an average particle size in the range of about 4 microns to about 7.5 microns, and the ion-transporting material is a separator saturated with a nonaqueous electrolyte and physically separates the anode and cathode and prevents direct electrical contact therebetween.

In a further aspect of the invention, an electrode is provided for use in an electrochemical device that converts chemical energy to electrode current, the electrode comprising a subfluorinated graphite fluoride having an average particle size in the range of about 4 microns to about 7.5 microns. Generally, the subfluorinated graphite fluoride is present in a composition that additionally includes a conductive diluent and a binder.

In still a further aspect of the invention, a method is provided for preparing an electrode for use in an electrochemical device, comprising the following steps:

contacting graphite powder having an average particle size in the range of 1 micron to about 10 microns with a gaseous source of elemental fluorine at a temperature in the range of about 375° C. to about 400° C. for a time period of about 5 to about 80 hours, producing a subfluorinated graphite fluoride having the formula CFₓ in which x is in the range of 0.06 to 0.63;

admixing the subfluorinated graphite fluoride with a conductive diluent and a binder to form a slurry; and

applying the slurry to a conductive substrate.

In still a further aspect of the invention, a rechargeable battery is provided that includes:

a first electrode comprising a subfluorinated graphite fluoride of formula CFₓ in which x is in the range of 0.06 to 0.63, the electrode capable of receiving and releasing cations of a metal selected from Groups 1, 2, and 3 of the Periodic Table of the Elements;

a second electrode comprising a source of the metal cations; and

a solid polymer electrolyte that permits transport of the metal cations and physically separates the first and second electrodes.

### BRIEF DESCRIPTION OF THE DRAWINGS

FIG. 1 depicts the thermogravimetric analysis (TGA) curves of graphite fluorides using a rate of 5° C./minute as evaluated in Example 2.

FIG. 2 provides the x-ray diffractometry measurements (XRD) on the graphite fluorides as determined in Example 2.

FIG. 3 provides the results of X-ray photoelectron spectroscopy (XPS) analysis of the graphite fluorides prepared as described in Example 1 and characterized in Example 2, with the C₁ₛ peaks in the primary spectrum having been deconvoluted.

FIG. 4 is a graph showing a linear relationship between the degree of fluorination and the C₁ₛ binding energies of the graphite fluorides prepared as described in Example 1 and characterized in Example 2.

FIG. 5 illustrates the discharge profile of the Li/graphite fluoride cells prepared and evaluated as described in Example 3.

FIG. 6 illustrates the effect of discharge rate on the discharge profile for sample CF_{0.52}, as described in Example 3.

FIG. 7 is a Ragone plot indicating the performance of all graphite fluoride cells prepared as described in Example 3.

### DETAILED DESCRIPTION OF THE INVENTION

In one embodiment, the invention provides an electrochemical device that converts chemical energy to electrochemical current, such a device being exemplified by a lithium battery. The device has a cathode, i.e., a positive electrode, comprising a subfluorinated graphite fluoride; an anode, i.e., a negative electrode, comprising a source of an ion corresponding to a metal of Groups 1, 2, or 3 of the Periodic Table of the Elements; and an ion-transporting material that physically separates the two electrodes and prevents direct electrical contact therebetween.

The subfluorinated graphite fluoride is a carbon-fluorine intercalation compound having an overall formula CFₓ wherein x is in the range of 0.06 to 0.63, preferably in the range of 0.06 to 0.52, more preferably in the range of 0.10 to 0.52, still more preferably in the range of 0.10 to 0.46, and optimally in the range of 0.33 to 0.46. The subfluorinated graphite fluoride used in connection with the present invention is generally a particulate material, e.g., a powder, wherein the average particle size is typically 1 micron to about 10 microns, preferably about 4 microns to about 7.5 microns, and optimally about 4 microns.

In the electrochemical devices of the invention, the subfluorinated graphite fluoride is normally present in a composition that also includes a conductive diluent such as may be selected from, for example, acetylene black, carbon black, powdered graphite, cokes, carbon fibers, and metallic powders such as powdered nickel, aluminum, titanium, and stainless steel. The conductive diluent improves conductivity of the composition and is typically present in an amount representing about 1 wt. % to about 10 wt. % of the composition, preferably about 1 wt. % to about 5 wt. % of the composition. The composition containing the subfluorinated graphite fluoride and the conductive diluent also, typically, contains a polymeric binder, with preferred polymeric binders being at least partially fluorinated. Exemplary binders thus include, without limitation, poly(ethylene oxide) (PEO), poly(vinylidene fluoride) (PVDF), a poly(acrylonitrile) (PAN), poly(tetrafluoroethylene) (PTFE), and poly(ethylene-co-tetrafluoroethylene) (PETFE). The binders, if present, represent about 1 wt. % to about 5 wt. % of the composition, while the subfluorinated graphite fluorides represent about 85 wt. % to about 98 wt. % of the composition, preferably about 90 wt. % to 98 wt. % of the composition.

The subfluorinated graphite fluorides are prepared by fluorination of a graphite material or a graphitizable material (see U.S. Pat. No. 6,358,649 to Yazami et al.), with powdered graphite having an average particle size in the range of 1 micron to about 10 microns being preferred. A particle size of about 4 microns to about 7.5 microns is more preferred, with an approximately 4 micron particle size being optimal.

An electrode provided with the aforementioned conductive composition can be manufactured as follows:

Initially, the subfluorinated graphite fluoride is prepared using a direct fluorination method, in which graphite powder preferably having an average particle size in the range of 1 micron to about 10 microns is contacted with a gaseous source of elemental fluorine at a temperature in the range of about 375° C. to about 400° C. for a time period of about 5 to about 80 hours, preferably about 15 to 35 hours. A subfluorinated graphite fluoride as described above results. A suitable gaseous source of elemental fluorine will be known to one of ordinary skill in the art; an exemplary such source is a mixture of HF and F₂ in a molar ratio somewhat greater than 1:1, e.g., 1.1:1 to 1.5:1.

The resulting subfluorinated graphite fluoride is then admixed with a conductive diluent and binder as described above, with the preferred weight ratios being about 85 wt/ % to about 98 wt. %, more preferably about 90 wt. % to about 98 wt. %, subfluorinated graphite fluoride; about 1 wt. % to about 10 wt. %, preferably about 1 wt. % to about 5 wt. %, conductive diluent; and about 1 wt. % to about 5 wt. % binder.

Typically, the slurry formed upon admixture of the foregoing components is then deposited or otherwise provided an a conductive substrate to form the electrode. A particularly preferred conductive substrate is aluminum, although a number of other conductive substrates can also be used, e.g., stainless steel, titanium, platinum, gold, and the like.

In a primary lithium battery, for example, the aforementioned electrode serves as the cathode, with the anode providing a source of lithium ions, wherein the ion-transporting material is typically a microporous or nonwoven material saturated with a nonaqueous electrolyte. The anode may comprise, for example, a foil or film of lithium or of a metallic alloy of lithium (LiAl, for example), or of carbon-lithium, with a foil of lithium metal preferred. The ion-transporting material comprises a conventional “separator” material having low electrical resistance and exhibiting high strength, good chemical and physical stability, and overall uniform properties. Preferred separators herein, as noted above, are microporous and nonwoven materials, e.g., nonwoven polyolefins such as nonwoven polyethylene and/or nonwoven polypropylene, and microporous polyolefin films such as microporous polyethylene. An exemplary microporous polyethylene material is that obtained under the name Celgard® (e.g., Celgard® 2400, 2500, and 2502) from Hoechst Celanese. The electrolyte is necessarily nonaqueous, as lithium is reactive in aqueous media. Suitable nonaqueous electrolytes are composed of lithium salts dissolved in an aprotic organic solvent such as propylene carbonate (PC), ethylene carbonate (EC), ethyl methyl carbonate (EMC), dimethyl ether (DME), and mixtures thereof. Mixtures of PC and DME are common, typically in a weight ratio of about 1:3 to about 2:1. Suitable lithium salts for this purpose include, without limitation, LiBF₄, LiPF₆, LiCF₃SO₃, LiClO₄, LiAlCl₄, and the like. It will be appreciated that, in use, an applied voltage causes generation of lithium ions at the anode and migration of the ions through the electrolyte-soaked separator to the subfluorinated graphite fluoride cathode, “discharging” the battery.

In another embodiment, the subfluorinated graphite fluoride composition is utilized in a secondary battery, i.e., a rechargeable battery such as a rechargeable lithium battery. In such a case, the cations, e.g., lithium ions, are transported through a solid polymer electrolyte —which also serves as a physical separator— to the subfluorinated graphite fluoride electrode, where they are intercalated and de-intercalated by the subfluorinated graphite fluoride material. Examples of solid polymer electrolytes include chemically inert polyethers, e.g., poly(ethylene oxide) (PEO), poly(propylene oxide) (PPO), and other polyethers, wherein the polymeric material is impregnated or otherwise associated with a salt, e.g., a lithium salt such as those set forth in the preceding paragraph.

It is to be understood that while the invention has been described in conjunction with the preferred specific embodiments thereof, the foregoing description as well as the examples that follow are intended to illustrate and not limit the scope of the invention. Other aspects, advantages, and modifications within the scope of the invention will be apparent to those skilled in the art to which the invention pertains.

In the following examples, efforts have been made to ensure accuracy with respect to numbers used (e.g., amounts, temperature, etc.) but some experimental error and deviation should be accounted for. Unless indicated otherwise, temperature is in degrees C and pressure is at or near atmospheric. All solvents were purchased as HPLC grade, and all reagents were obtained commercially unless otherwise indicated.

### EXAMPLE 1

### Synthesis of (CFₓ)_{N} Materials

Four samples of (CFₓ)ₙ (A, B, C, D) were synthesized by direct fluorination of a natural graphite powder obtained from Centre National de la Recherche Scientifique (CNRS, in Madagascar) and Clermont-Ferrand University Lab (France). The average particle size for the precursor was 7.5 μm for samples A, B, and D whereas an average particle size of 4 μm was used for sample C. The fluorination temperature ranged from 375° C. to 400° C., and was adjusted to obtain the desired F/C ratios. A battery grade carbon monofluoride (E) derived from a petroleum coke was obtained from Advance Research Chemicals Inc. (ARC, Tulsa, Okla., USA). Table 1 summarizes the synthesis conditions used for each sample:

TABLE 1
Synthesis conditions for the (CFₓ)ₙ samples

| | Sample | | | | |
|---|---|---|---|---|---|
| | A | B | C | D | E |
| Precursor | NG | NG | NG | NG | Coke |
| Particle Size | ˜7.5 μm | ˜7.5 μm | ˜4 μm | ˜7.5 μm | ˜15-30 μm |
| Temperature | 375° C. | 380° C. | 390° C. | 400° C. | N/A |
| Duration | 17 hrs | 32 hrs | 20 hrs | 80 hrs | N/A |

NG = natural graphite

### EXAMPLE 2

### Physical Characterization of (CFₓ)_{N} Materials

Methods:

Scanning electron microscopy (SEM, JEOL instrument) was performed to observe the particles' morphology and analyze their composition via electron-dispersive x-ray (EDX) spectrometry. Micrographs were taken at various magnifications ranging from 500× to 10,000×.

The chemical composition of each sample was determined using several methods. For samples A-D, the weight uptake during the fluorination reaction was used to determine the F/C ratio. EDX spectrometry provided semi-quantitative analyses of carbon and fluorine for all samples. These measurements were acquired on the SEM JEOL instrument with a Li-drifted Si crystal detector, at a working distance of 10 mm, and analyzed using INCA software. Additional elemental analysis was performed for sample E by a carbonate fusion method at ARC.

The thermal stability of the material was investigated by thermogravimetric analysis (TGA) performed on a Perkin Elmer Pyris Diamond instrument. The weight loss of the material under argon atmosphere was recorded while it was being heated at a rate of 5° C.·min⁻¹ between 25° C. and 900° C.

X-ray diffractometry (XRD) measurements were performed on a Rigaku instrument with CuK_{α} radiation. Silicon powder (˜5 wt. %) was mixed in all samples and used as an internal reference. The spectra obtained were fitted on Xpert Highscore software. The resulting profiles were used in combination with CefRef software to determine the ‘a’ and ‘c’ crystal parameters of the hexagonal cell (P₋₆ₘ₂) as proposed by Touhara et al. (1987) Z. Anorg All. Chem. 544:7.

Results:

The scanning electron micrographs showed particle sizes ranging from about 2 to about 10 μm while the observed particle size of the commercially available (CF₁)ₙ ranges from 10 to 35 μm. In addition to the particle size, the morphology of the two groups of samples seemed to differ. The sub-fluorinated (CFₓ)ₙ samples consisted of very thin flakes while the carbon monofluoride samples were bulkier. This difference presumably derives from the use of a natural graphite precursor for samples A, B, C, and D, and a larger petroleum coke precursor for sample E.

The weight uptake during the fluorination of the graphite materials was converted to an F/C ratio, with the measurements averaged over a minimum of five different areas of the sample. Table 2 summarizes the composition results obtained for each sample and method. The composition of samples A, B, C, and D as determined by weight uptake and EDX measurement correlated quite closely, as illustrated by the results set forth in the table. The composition of sample E as determined by a carbonate fusion method was identical to that determined by EDX measurements.

TABLE 2
Chemical composition determined by weight gain (A-D),
EDX (A-E), and carbonate fusion method (E)

| | | Sample | | | | |
|---|---|---|---|---|---|---|
| | | A | B | C | D | E |
| F/C Ratio | Weight Gain | 0.33 | 0.46 | 0.52 | 0.63 | N/A |
| | EDX | 0.36 | 0.47 | 0.60 | 0.67 | 1.08 |
| | ARC | | | | | 1.08 |

Given the results summarized in Table 2, samples A, B, C, D, and E will also be identified hereinafter as CF_{0.33}, CF_{0.46}, CF_{0.52}, CF_{0.63}, and CF_{1.08}, respectively.

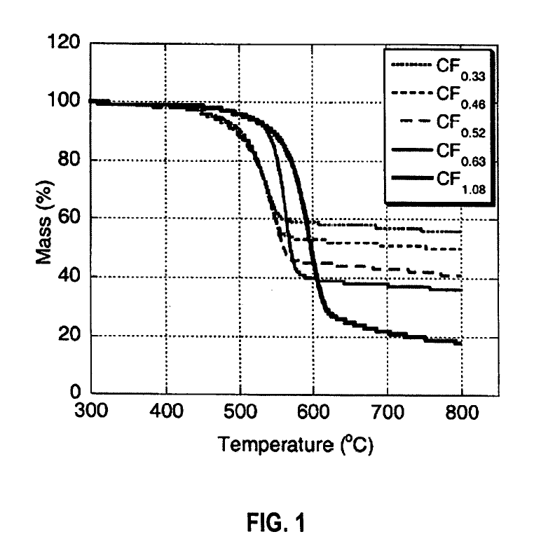

The TGA traces of all samples are shown in FIG. 1. Below a temperature of 400° C., materials A-D were found to be very stable, with less than 1% observed loss of mass. Between 400° C. and 600° C., materials A-D underwent a noticeable decrease in mass. While the profile was similar for A, B, and C, material D exhibited a sudden drop in the temperature range of 525° C. to 580° C. Above 600° C., no significant loss of mass was observed until about 900° C., with the weight decreasing gradually, at a rate of less than 2% per degree. Material E has the same thermogram profile as material D, but exhibits somewhat higher thermal stability, beginning to decompose at about 450° C. and stopping at around 630° C. Table 3 summarizes the TGA results, highlighting a higher initial weight loss for CF_{0.52}. While not wishing to be bound by theory, it is presumed that this is due to the smaller particle size, and thus larger surface area, of the precursor. More surface adsorption effects cause greater initial weight loss at lower temperatures.

TABLE 3
Summary of the TGA results on the (CFₓ)ₙ powders

| Sample | | CF_{0.33} | CF_{0.46} | CF_{0.52} | CF_{0.63} | CF_{1.08} |
|---|---|---|---|---|---|---|
| Temper- | 1% wt. Loss | 380 | 374 | 328 | 393 | 426 |
| ature | 2% wt. Loss | 423 | 427 | 403 | 459 | 467 |
| After | 3% wt. Loss | 443 | 448 | 433 | 485 | 485 |

| | | | | | |
|---|---|---|---|---|---|
| wt. % Remaining | 55.6 | 49.7 | 40.9 | 35.7 | 18.4 |
| at 800° C. | | | | | |

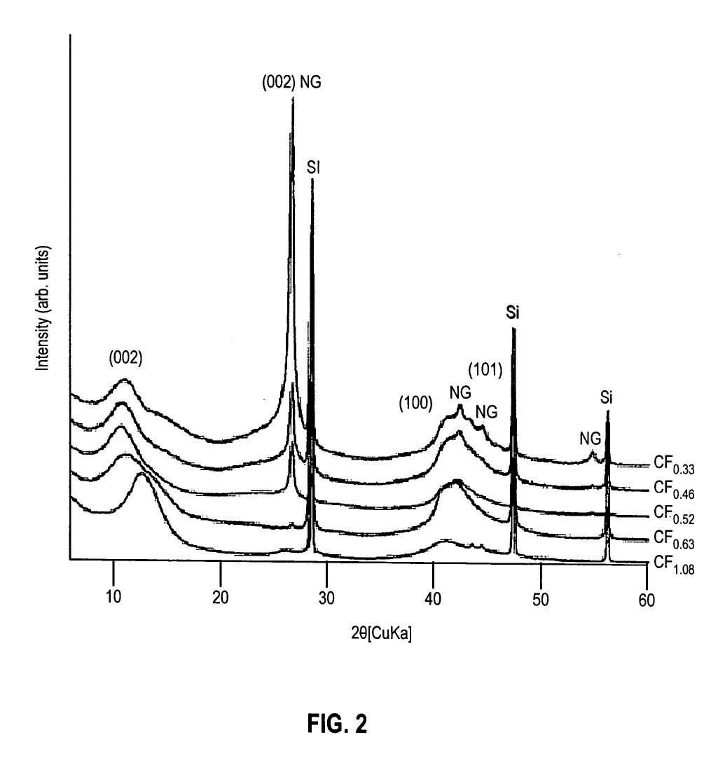

The XRD patterns, in FIG. 2, show a combination of broad and sharp peaks, with intensity variations reflecting the difference in the degree of fluorination. The sharper peaks originate from the un-fluorinated precursor (graphite for CF_{0.33}, CF_{0.46}, CF_{0.52}, CF_{0.63}, and coke for CF_{1.08}) and are most evident in samples CF_{0.33}, CF_{0.46}, CF_{0.52}. The strongest graphite peak (002) is observed at 26.5° with relative intensity decreasing with x. The broad peaks corresponding to the fluorinated phase are found at about 10°, 25°, and 40-45° for samples CF_{0.33} to CF_{0.63}, and at about 13°, 26° and 41° for sample CF_{1.08}. Table 4 shows the ‘a’ and ‘c’ parameters obtained for the fluorinated phases assuming a hexagonal lattice structure.

TABLE 4
Summary of a and c parameters of the hexagonal unit
cell derived from XRD measurements

| Sample | CF_{0.33} | CF_{0.46} | CF_{0.52} | CF_{0.63} | CF_{1.08} |
|---|---|---|---|---|---|
| a(\acute{Å}) | 2.54 | 2.54 | 2.54 | 2.54 | 2.54 |
| c(\acute{Å}) | 16.65 | 16.55 | 16.20 | 16.65 | 12.70 |

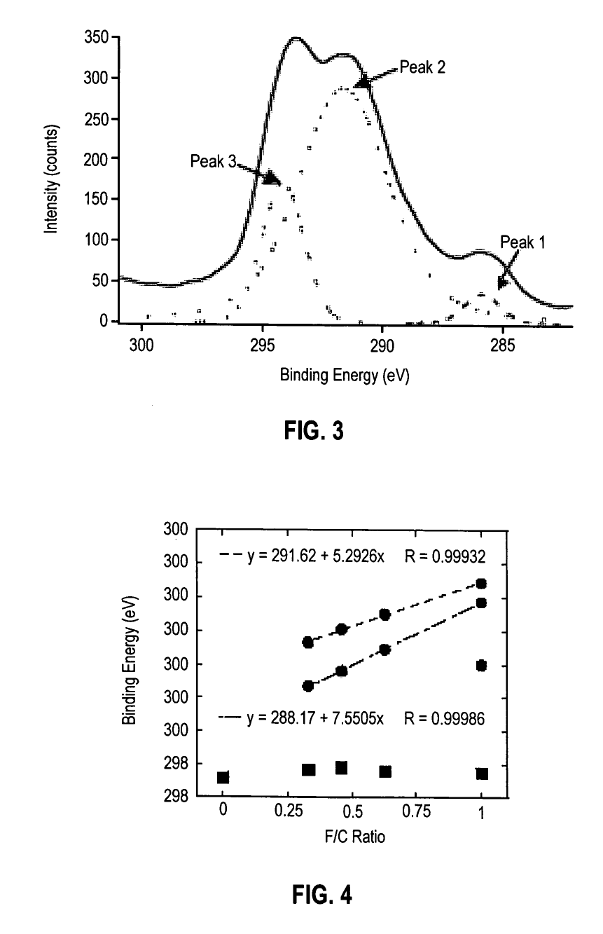

The C₁ₛ and F₁ₛ binding energy spectra were collected and analyzed using X-ray photoelectron spectroscopy (XPS). Deconvolution of the C₁ₛ peaks (FIG. 3) revealed two peaks other than the graphitic peak corresponding to x<1, and three peaks in addition to the peak found at 285.5 eV (corresponding to x=l). These peaks correspond to the sp³-carbon from the C—F bonds, and the CF₂ or CF₃ bordering the graphene layers. Deconvolution of the F₁ₛ peaks resulted in two peaks matching the C₁ₛ peaks. FIG. 4 shows a linear relationship between the degree of fluorination and the C₁ₛ binding energies.

### EXAMPLE 3

### Electrochemical Performance of (CFₓ)_{N} Materials

Conventional 2032 coin cells were assembled to test the electrochemical performance of the (CFₓ)ₙ materials. The cathode was prepared by spreading a slurry of 5 g (CFₓ)ₙ, 0.62 g carbon black, and 0.56 g polytetrafluoroethylene (PTFE) -based binder on an aluminum substrate. The anode was a lithium metal disc, and the separator consisted of a microporous polypropylene Celgard® 2500 membrane. The thicknesses of the cathode, anode, and separator were 15 mm, 16 mm, and 17.5 mm respectively. The electrolyte used was 1.2M LiBF₄ in a 3:7 v/v mixture of propylene carbonate (PC) and dimethyl ether (DME). Stainless steel spacers and a wave washer were used to maintain sufficient pressure inside the coin cell. The coin cells were discharged on an Arbin instrument by applying a constant current with a voltage cutoff of 1.5 V. The discharge rates ranged from 0.01 C to 2.5 C, at room temperature. The C-rate calculation was based on a theoretical capacity Qₜₕ in mAh/g determined by equation (2). A minimum of three cells were used for each test condition.

$${Q}_{th} ( x ) = \frac{x F}{3.6 ( 12 + 19 x )} \qquad ( 2 )$$

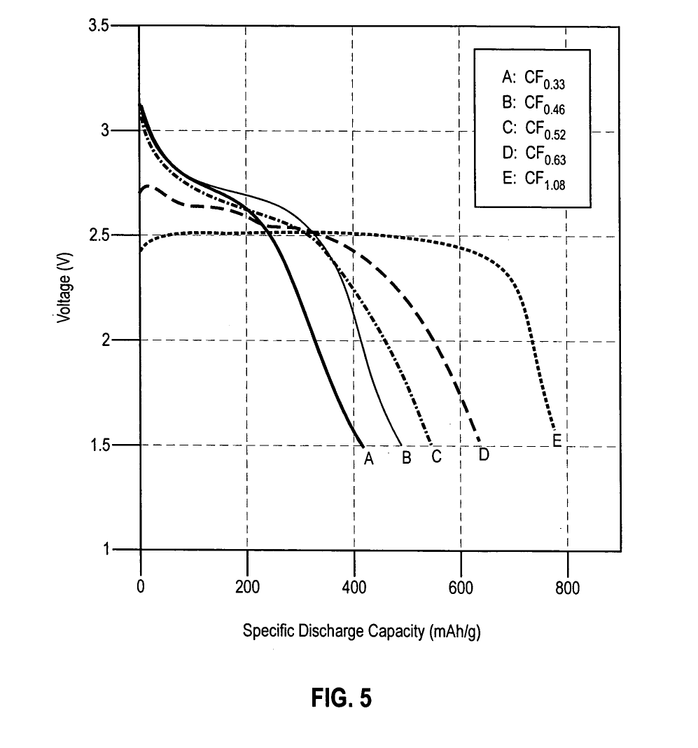

The discharge profile of the Li/(CFₓ)ₙ cells is shown in FIG. 5. While the battery grade carbon monofluoride exhibited the characteristic plateau around 2.5 V, the discharge profiles of samples CF_{0.33}, CF_{0.46}, CF_{0.52} differed greatly in their voltage and shape. The discharge started at a higher voltage of about 3 V, dropped to about 2.8 V, then slowly decreased to about 2.5 V before a sharper drop to 1.5 V. The discharge curve of sample CF_{0.63} falls in between the two previous groups. In the latter sample the initial voltage is found at around 2.7 V; the slope of the curve is flatter than that of CF_{0.33}, CF_{0.46}, CF_{0.52}, but steeper than CF_{1.08}. The discharge capacity differed depending on the discharge rate as well as the F/C ratio. The variations in potential are presumably due to the difference in the electrical conductivity of the materials. The existence of an unfluorinated graphitic phase may result in a higher conductivity between the fluorinated grains of graphite fluoride, which reduce cathodic overpotential. As a result, the lower the F/C the higher the discharge voltage plateau.

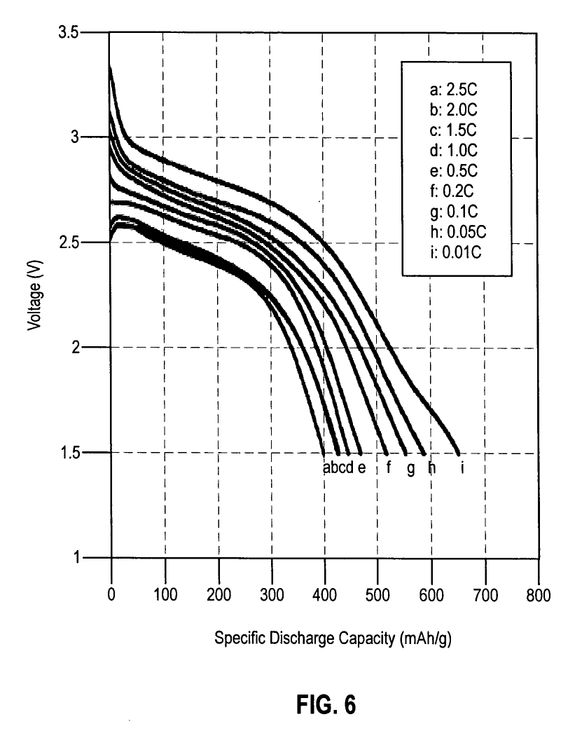

For each material, the increase in the discharge current caused a decrease in the average discharge voltage and a reduced capacity. FIG. 6 illustrates the effect of the discharge rates on the discharge profile for sample CF_{0.52}. At the lowest discharge rates (C/100 to C/5), the voltage drops gradually from an open-circuit voltage of about 3.4 V to 3 V. The initial voltage drop commonly observed in the fast discharges of Li/(CFₓ)ₙ batteries was observed only for rates of 1 C or higher. The discharge curves corresponding to 1.5 C, 2 C, and 2.5 C are very similar in voltage and capacity, and exhibit a significant voltage drop at the beginning of discharge. Similar effects were observed for the other materials. Such a drop in the potential for higher discharge rate is associated with a steep increase in the overpotential at the higher discharge currents. Again, for the sub-fluorinated samples, the conductivity of the materials should be higher than that of the battery grade carbon monofluoride, and, as a result, the cell over-potential at high discharge rates is lower.

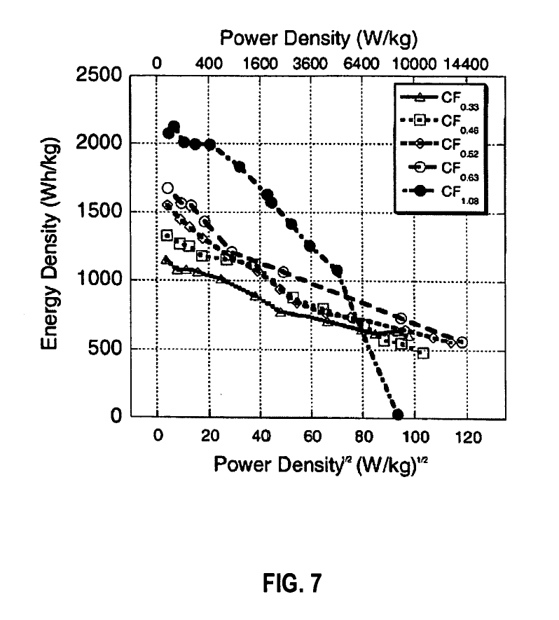

In order to compare the performance of the (CFₓ)ₙ materials under different discharge rates, a Ragone plot is presented in FIG. 7. It shows the achieved energy density E (Wh·kg⁻¹) versus the power density P (W·kg⁻¹) traces. E and P are determined from the discharge curves using equations (3) and (4):

$$\begin{matrix}E = \frac{q ( i ) \times < {e}_{i} >}{m} & ( 3 ) \\ P = \frac{i \times < {e}_{i} >}{m} & ( 4 )\end{matrix}$$

In the equations for E and P, q(i) and <eᵢ>respectively represent the discharge capacity (Ah) and the average discharge voltage (V) at current i (A), and m is the mass of active (CFₓ)ₙ in the electrode (kg). Note that the P scale in the Ragone plot is given as P^{1/2} for clarity. As expected, carbon monofluoride exhibited a very high energy density (over 2000 Wh·kg⁻¹) for low rates of discharge (<C/10) while the sub-fluorinated graphites have significantly lower energy densities. Below 1000 W·kg⁻¹, the energy density was approximately proportional to the F/C ratio of the materials. Beyond that point, the operating voltage and discharge capacity of carbon monofluoride are drastically reduced causing a large decrease in the energy density. Similarly, the capacity of materials A-D is also reduced; however, the operating voltage is still greater than that of sample E, and the energy density is greater than 500 Wh·kg⁻¹ over 2.5C.

Accordingly, the results show that partially fluorinated graphite fluorides can outperform the traditional fluorinated petroleum coke as electrodes in electrochemical devices such as lithium batteries. Although lower fluorination content decreased specific discharge capacity of the material somewhat, that decrease was overshadowed by a very substantial increase in battery performance at high discharge rates.

I claim:

1. An electrochemical device comprising an anode, a cathode, and an ion-transporting material therebetween, wherein the cathode comprises a subfluorinated graphite fluoride of formula CFₓ in which x is in the range of 0.06 to 0.63.

2. The device of claim 1, wherein x is in the range of 0.06 to 0.52.

3. The device of claim 2, wherein x is in the range of 0.10 to 0.52.

4. The device of claim 3, wherein x is in the range of 0.10 to 0.46.

5. The device of claim 4, wherein x is in the range of 0.33 to 0.46.

6. The device of claim 1, wherein the subfluorinated graphite fluoride comprises a particulate material.

7. The device of claim 6, wherein the subfluorinated graphite fluoride has an average particle size in the range of about 1 micron to about 10 microns.

8. The device of claim 7, wherein the subfluorinated graphite fluoride has an average particle size in the range of about 4 microns to about 7.5 microns.

9. The device of claim 8, wherein the subfluorinated graphite fluoride has an average particle size of about 4 microns.

10. The device of claim 1, wherein the subfluorinated graphite fluoride is in a composition further comprising a conductive diluent and a binder.

11. The device of claim 10, wherein the conductive diluent is selected from acetylene black, carbon black, powdered graphite, cokes, carbon fibers, metallic powders, and combinations thereof.

12. The device of claim 11, wherein the conductive diluent is acetylene black.

13. The device of claim 10, wherein the binder is polymeric.

14. The device of claim 13, wherein the binder is a fluorinated hydrocarbon polymer.

15. The device of claim 1, wherein the anode comprises a source of ions of a metal selected from Groups 1, 2, and 3 of the Periodic Table of the Elements.

16. The device of claim 15, wherein the ions are lithium ions.

17. The device of claim 16, wherein the source of lithium ions is selected from lithium metal, a lithium alloy, and a carbon-lithium material.

18. The device of claim 17, wherein the source of lithium ions is lithium metal.

19. The device of claim 1, wherein the ion-transporting material physically separates the anode and the cathode and prevents direct electrical contact therebetween.

20. The device of claim 19, wherein the ion-transporting material comprises a polymeric material and a nonaqueous electrolyte.

21. The device of claim 1, wherein the device is a primary lithium battery and:
the anode comprises a source of lithium ions;
the cathode comprises a subfluorinated graphite fluoride of formula CFₓ in which x is in the range of 0.06 to 0.52, wherein the subfluorinated graphite fluoride comprises a particulate material having an average particle size in the range of about 4 microns to about 7.5 microns; and
the ion-transporting material physically separates the anode and the cathode and prevents direct electrical contact therebetween, wherein the material comprises a nonaqueous electrolyte.

22. The device of claim 21, wherein x is in the range of 0.10 to 0.52.

23. The device of claim 22, wherein x is in the range of 0.10 to 0.46.

24. The device of claim 23, wherein x is in the range of 0.33 to 0.46.

25. An electrode for use in an electrochemical device that converts chemical energy to electrical current, the electrode comprising a subfluorinated graphite fluoride of formula CFₓ in which x is in the range of 0.10 to 0.52, wherein the subfluorinated graphite fluoride comprises a particulate material having an average particle size in the range of about 4 microns to about 7.5 microns.

26. The electrode of claim 25, wherein x is in the range of 0.10 to 0.52.

27. The electrode of claim 26, wherein x is in the range of 0.10 to 0.46.

28. The electrode of claim 25, wherein x is in the range of 0.33 to 0.46.

29. The electrode of claim 25, wherein the subfluorinated composition further comprising a conductive diluent and a binder.

30. The electrode of claim 29, wherein the conductive diluent is selected from acetylene black, carbon black, powdered graphite, cokes, carbon fibers, metallic powders, and combinations thereof.

31. The electrode of claim 30, wherein the conductive diluent is acetylene black.

32. The electrode of claim 29, wherein the binder is polymeric.

33. The electrode of claim 32, wherein the binder is a fluorinated hydrocarbon polymer.

34. A method for preparing an electrode for use in an electrochemical device, comprising:
contacting graphite powder having an average particle size in the range of 1 micron to about 10 microns with a gaseous source of elemental fluorine at a temperature in the range of about 375° C. to about 400° C. for a time period of about 5 to about 80 hours, whereby a subfluorinated graphite fluoride is provided having the formula CFₓ in which x is in the range of 0.06 to 0.63;
admixing the subfluorinated graphite fluoride with a conductive diluent and a binder to form a slurry; and
applying the slurry to a conductive substrate.

35. The method of claim 34, wherein the graphite powder has an average particle size in the range of 4 microns to about 7.5 microns.

36. The method of claim 34, wherein the time period is in the range of about 15 to about 35 hours.

37. A rechargeable battery comprising:
a first electrode comprising a subfluorinated graphite fluoride of formula CFₓ in which x is in the range of 0.06 to 0.63, and capable of receiving and releasing cations of a metal selected from Groups 1, 2, and 3 of the Periodic Table of the Elements;
a second electrode comprising a source of said metal cations; and
a solid polymer electrolyte that permits transport of said metal cations and physically separates the first and second electrodes.

38. The rechargeable battery of claim 37, wherein the metal is lithium.
